(19) United States
(12) Patent Application Publication
(10) Pub. No.: US 2003/0021886 A1
(43) Pub. Date: Jan. 30, 2003

(54) Method of printing and printing machine

(76) Inventor: Stephen James Baele, Dorset (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/204,736

(22) PCT Filed: Feb. 20, 2001
(86) PCT No.: PCT/GB01/00715

(51) Int. Cl. B05D 5/12; B05D 1/32

(52) U.S. Cl. 427/8; 427/282; 427/96; 118/668

(57) ABSTRACT

Screen printing apparatus including two cameras for effecting alignment of a stencil with a PCB or circuit board (20). The circuit board (20) is mounted on a table (12) movable relative to a stencil (26) fixed in position on the apparatus. The table is able to move in a first direction between a circuit board loading position and a print position. A first camera (11) for viewing the circuit board (20) is mounted on the apparatus for movement in a direction transverse to the first direction. A second camera (13) for viewing the stencil (26) is mounted on the table (12) and is mounted for movement in a direction perpendicular to the first direction. Thus each camera (11,13) is effectively able to move in X any Y axes relative to the object (20,26) it views. By means of viewing fiducial marks on the circuit board (20) and the stencil (26) with the cameras as the table (12) moves from the load position to the print position, a control unit of the apparatus ascertains the relative positions of the circuit board (20) and the stencil (26), aligns the stencil and circuit board and then prints solder paste onto the circuit board (20) in a pattern determined by the stencil (26).

The present invention relates to a method of printing and a printing machine and, in particular, a method of printing and a printing machine for printing a substance onto a circuit board in a predetermined pattern and substantially in accordance with a desired orientation.

It is common, when manufacturing circuit boards for receiving components, to print solder paste onto the surface of the circuit board in a predetermined pattern and so that the pattern of solder paste so printed is correctly aligned with the particular layout of the circuit board.

A known method employed for printing solder paste onto a circuit board is stencil printing. One prior art printing machine includes a movable table on which a circuit board may be mounted, the table being movable between a printing position in which solder paste may be printed on the board in a pattern determined by a stencil (i.e. the board being directly beneath the stencil) and a load position in which the board may be loaded onto the table (i.e. the board being moved out from beneath the stencil). The board may be viewed by two movably mounted cameras when in the load position.

Printing of solder paste with that prior art printing machine is effected by means of a skilled operator setting up the printing machine by performing the following steps: 1) the operator places a circuit board on the table and manually adjusts the positions of the cameras, if necessary, so that each respective camera can view a respective unique shape defined by a part of the wiring circuit of the board, 2) the printing machine is then taught to recognise the respective shapes, 3) the printing machine then performs a series of given movements of the table, the machine ascertaining the effect of each mechanical movement on the positions of the images viewed by the cameras, thereby enabling the machine to calibrate itself to compensate for the change in position of the cameras 4) the printing machine is then instructed to print an alignment test image by moving the table beneath the stencil by a given distance and printing solder paste onto the circuit board, and then moving the table out from beneath the stencil, and 5) the printing machine views with the cameras the printed alignment test image (of solder paste) on the circuit board, the printing machine storing data relating to the orientation of the printed image of solder paste. Circuit boards may then be printed, by loading a circuit board onto the load table, the printing machine recognising the respective shapes on the circuit board and then, in accordance with the stored data relating to the printed alignment test image, the machine aligning the board by moving the load table (in the load position) effectively to align the wiring circuit of the board with the alignment test image and then moving the table to the print position and printing on the board.

Rather than ascertaining the position of the circuit board by recognising parts of the wiring circuit, the prior art printing machine can be taught to recognise non-printable images, for example, fiducial marks. Once the printing machine has been set up by performing the above-mentioned steps, steps 1 to 5, the printing machine can be taught to utilise fiducial marks by performing the following steps: 6) the machine aligns the board by recognising the aforementioned respective shapes and then effectively aligning the wiring circuit of the board with the alignment test image, 7) the operator then manually repositions the cameras so that each camera can view a fiducial mark, 8) the printing machine is then taught to recognise the respective fiducial marks and the machine stores data relating to the orientation of the fiducial marks of the board when in the load position (the board being in alignment for printing by virtue of step 6), and 9) the printing machine recalibrates itself to accommodate for the movement in the camera positions.

The prior art method described above suffers from many disadvantages. The prior art method does not include a step in which the position of the stencil is directly ascertained; rather, the method relies on the performance of an alignment test print. If the stencil or the cameras are moved after the printing machine has been set up, the substance will not be printed in the correct orientation. That method therefore suffers from the disadvantage that there is no automatic compensation for subsequent errors in alignment of the substance printed on the boards. Furthermore, the machine needs to calibrate itself each time the cameras are moved. If fiducial marks are to be used to effect alignment of the circuit board, the cameras need to be manually repositioned. Also, a skilled operator is required to perform the set-up of the printing machine before each printing run.

It is an object of the present invention to provide a method of printing and a printing machine that mitigate one or more of the above-mentioned disadvantages associated with the methods of the prior art.

Accordingly, the present invention provides a method of printing a substance onto a circuit board in a predetermined pattern and substantially in accordance with a desired orientation comprising the steps of

a) providing a printing machine comprising

a circuit board holder to which a circuit board may be secured,

a stencil holder to which a stencil is secured,

a camera system comprising at least one moveably mounted camera and a control unit, wherein

the circuit board holder and stencil holder are so arranged that they are movable relative to each other between a load position, in which a circuit board may be secured to or released from the circuit board holder, and a print position in which the printing machine is able to print a substance onto a circuit board secured to the circuit board holder in a pattern determined by the stencil and in an orientation determined by the relative orientation of the circuit board holder and the stencil holder,

the circuit board holder and stencil holder are so arranged that said relative orientation is adjustable, and wherein said at least one camera is so mounted that relative movement of the circuit board holder and the stencil holder causes movement of the camera relative to one of the circuit board holder and the stencil holder and is so mounted that the camera is traversable relative to either or both of the circuit board holder and the stencil holder.

b) with the circuit board holder and stencil holder in the load position, loading a circuit board onto the circuit board holder,

c) moving the circuit board holder and stencil holder relative to each other from the load position towards the print position,

d) during the step of moving the circuit board holder and stencil holder from the load position towards the print position, viewing the circuit board with the camera system,

e) sending signals from the camera system to the control unit,

f) ascertaining the relative movement required to position the circuit board holder and stencil holder relative to each other so that the printing machine is able to print a substance onto the circuit board in the desired orientation, including a step of ascertaining the relative orientation of the circuit board and the stencil from the signals sent from the camera system and data in the control unit relating to the relative orientation of the stencil,

g) moving the circuit board holder and stencil holder relative to each other in accordance with the relative movement so ascertained, and then

h) printing a substance onto the circuit board.

A fully automated screen printer is described in EP-0 394 568 A (MPM Corp.). During normal operation of that screen printer the table, on which the circuit board is placed, does not move from beneath the screen/stencil. The printer is provided with movable video probes able to move to and from a position within a gap between the board and the stencil. Each video probe is rotatable through 180 degrees to enable the probes to view each of the board and the stencil. The video probes are therefore relatively complicated in construction. The method of the present invention may be provided with a camera system having a much simpler construction. The MPM screen printer also suffers from the disadvantage that the gap between the stencil and the circuit board (in the direction normal to the plane in which stencil lies) has to be large enough for the cameras to move between the board and the stencil.

A further screen printing apparatus is described in U.S. Pat. No. 6,011,629 (Matsushita Electric Industrial Co.). The method of alignment used therein involves the use of a first and a second camera. The first camera for observing a substrate is fixedly mounted on a stationary support frame of the screen printing apparatus (and therefore in fixed relation to the screen mask). The second camera for viewing the screen mask is fixedly mounted on a table on which the substrate is mounted, the table being movable in the Y-direction. That table is itself movably mounted on a further table movable in the X-direction. Thus the first camera remains stationary relative to the apparatus, whereas the second camera is movable in the X and Y directions relative to the apparatus. In order to view either of the substrate or the screen mask, the table on which the substrate and the second camera are fixedly mounted is moved relative to the screen mask and the first camera. Such a method has significant disadvantages. Firstly, the relatively massive and bulky tables need to be moved in both X and Y directions in order for images to be captured by the cameras (so as to judge whether the screen mask and substrate need aligning). In particular, the tables must be arranged to be movable in a direction perpendicular to the direction of movement between the load and print positions by a distance sufficient to allow observation of the relevant portions of the substrate and screen mask. Secondly, the fact that the position of each camera, relative to the object viewed thereby, is not movable independently of the movement of the moveable table may make it necessary to reverse the movement of the table in the direction from the load position to the print position in order to make sufficient observations to perform the alignment.

With reference to the method of the present invention, the relative movement of the circuit board holder and the stencil holder may be such that the stencil holder remains stationary relative to the machine. Alternatively, the relative movement may be such that the circuit board holder remains stationary relative to the machine.

Preferably, the printing machine of the method of the present invention is arranged such that at least one camera is mounted for viewing a circuit board, relative movement of the stencil holder between the load position and the print position causes relative movement of that camera in a first direction relative to the circuit board, and the camera is mounted for movement relative to the stencil holder in a second direction transverse to the first direction, so that the camera is able to move to view different regions of the circuit board. Such an arrangement may allow the camera to view any region of the circuit board by means of only one prime mover in addition to the prime mover that effects relative movement of the circuit board holder and the stencil holder in the first direction. The camera is preferably movably mounted on the stencil holder or on a fixture that is fixed in relation to the stencil holder. Advantageously, the camera system of the printing machine includes two cameras, one camera of which is mounted for viewing a stencil, wherein relative movement of the circuit board holder between the load position and the print position causes relative movement of said one camera in a first direction and said one camera is mounted for movement relative to the circuit board holder in a second direction transverse to the first direction, so that the camera is able to move to view different regions of the stencil. Said one camera is preferably movably mounted on the circuit board holder or on a fixture that is fixed in relation to the circuit board holder.

The signals from the camera system used by the control unit may relate to an image of part of the object viewed by the relevant camera. A camera of the camera system may be able to view only part of an object viewed by that camera. The camera is preferably movable relative to the object in two non-parallel directions parallel to the plane on which the object lies. The step of moving the circuit board holder and stencil holder relative to each other between the load position and the print position advantageously effects movement of the camera relative to the object in one of the said two non-parallel directions. Preferably each camera moves with one of the circuit board or stencil whilst viewing the other of the circuit board or stencil. (It will be understood that the term the “object” means in this context case either the circuit board or the stencil as the case may be).

The camera system preferably comprises two cameras, one of which is arranged to view the circuit board and the other of which is arranged to view the stencil. The cameras may be arranged so that the camera able to view the circuit board is not able to view the stencil and so that the camera able to view the stencil is not able to view the board. Having cameras dedicated to viewing either one of the board and stencil simplifies the method of the present invention.

Preferably, the camera system comprises at least one CCD monochrome or colour camera and a light source associated therewith. In the case where there is a camera movably mounted on one of the stencil holder and the circuit board holder, the camera being arranged to view the object on the other of the stencil holder and the circuit board holder, the camera is preferably positioned so that the surface of the object visible by the camera is relatively close to the camera (for example, the separation being less than 100 mm, preferably less than 60 mm and more preferably less than 30 mm). Preferably, the printing machine is arranged to reduce reflections of ambient light off the surface of the object, or other surfaces, into the camera by the provision of, for example, a cover. Arranging the camera close to the relevant object to be viewed can also help to reduce unwanted reflections of light. Also, such an arrangement may facilitate more efficient illumination of the area of the object viewed by the camera.

Advantageously, the printing machine and camera system are so arranged that the machine is able to ascertain the relative position(s) of the camera(s) from, for example, data including information relating to the movements of the camera or cameras previously effected by the printing machine.

Preferably, the camera system is so arranged that the direction in which each camera views, is always substantially perpendicular to the plane on which the object viewed lies.

The circuit board may, in step b), be loaded manually, for example by an operator. Alternatively, the loading of a circuit board may be performed automatically. The machine may, for example, form a part of a production line, assembly line or the like. The step of loading a circuit board onto the circuit board holder may be performed by a robot, for example a suitably programmed robotic arm. Circuit boards may be automatically conveyed to the circuit board holder by a suitable conveying means, for example a driven conveyor belt. A circuit board may similarly be unloaded in the same manner as the loading of the circuit board. For example, the circuit board may, after it has been printed on, be removed from the circuit board holder either manually or automatically.

The data relating to the relative orientation of the stencil may be stored in the control unit in, for example, non-volatile memory in the control unit. Such data may be stored in the memory on manufacture of the printing machine. More preferably, however, the method of the invention includes a step in which such data is ascertained. The data relating to the orientation of the stencil may be ascertained during the printing machine operating cycle for each and every circuit board. Preferably, however, the data is ascertained and then stored in the control unit for use in subsequent operating cycles and need therefore be ascertained less often. The data is preferably ascertained from signals from the camera system, the camera system viewing the stencil before or during the operating cycle. In such a case, the camera or cameras for viewing the stencil may be fixedly mounted on the printing machine.

Preferably, during step d) the stencil is viewed with the camera system, said data in the control unit relating to the relative orientation of the stencil being ascertained from the signals sent from the camera system to the control unit.

The method advantageously further includes the steps of storing in the control unit said data relating to the relative orientation of the stencil, moving the circuit board holder and stencil holder relative to each other from the print position to the load position and removing the circuit board, loading a further circuit board onto the circuit board holder, and printing a substance onto that further circuit board by repeating steps c) to h) of claim 1 in relation to that further circuit board.

Thus during printing of the further circuit board and subsequent circuit boards there is no need for the camera system to view the stencil or send signals relating to the stencil to the control unit. It is however preferable for the method to check periodically the accuracy of the data relating to the relative orientation of the stencil, in case the orientation has altered in any way, for any reason. For example, accidental knocks to the printing machine may cause a change in the relative orientation of the stencil. Accordingly, the method further comprises the steps of: printing on a multiplicity of circuit boards in succession, and then, during a subsequent printing run, viewing the stencil with the camera system, and sending signals from the camera system to the control unit, and refreshing the data stored in the control unit relating to the relative orientation of the stencil.

Advantageously, the stencil is removably secured to the stencil holder and the method further includes a step in which the stencil is secured to the stencil holder. The printing machine is advantageously able to be used with a different stencil to print a substance in a different pattern and orientation on a circuit board. In that case, the control unit preferably has a memory in which data relating to the stencil and the circuit board is held, the data enabling the machine to ascertain the relative orientation of the circuit board and the stencil from the signals sent from the camera system and to ascertain the relative movement required to position the circuit board holder and stencil holder relative to each other so that the printing machine is able to print a substance onto the circuit board in the desired orientation. Of course, the data relating to a particular type of stencil and circuit board need only relate to one of the stencil and circuit board in the case where the data relating to one can be deduced from the other. Data relating to certain stencils and the corresponding respective circuit boards may be stored in the memory on manufacture of the printing machine. Preferably, the method includes a step in which data relating to a particular type of stencil and circuit board is stored in the memory of the control unit. The control unit is advantageously able to store data relating to a multiplicity of different types of stencils and corresponding circuit boards.

The stencil advantageously has a plurality of fiducial points arranged in relation to its surface, the respective positions of fiducial points being ascertainable, in use, by the control unit from signals received from the camera system, whereby the relative orientation of the stencil may be ascertained. Advantageously, the circuit board also has a plurality of fiducial points arranged in relation to its surface, the respective positions of fiducial points being ascertainable by the control unit from signals received from the camera system, whereby the relative orientation of the circuit board may be ascertained. The layout of the fiducial points of the stencil need not be related to the layout of the fiducial points of the circuit board.

A fiducial point may be defined by a shape, the shape, for example, being etched onto the surface of the circuit board (or stencil as the case may be). In the case of a circuit board the shape may, for example, be a portion of a wiring circuit etched onto its surface. Preferably, each fiducial point is defined by an easily recognisable shape that allows the control unit easily to ascertain the point so defined. For example the shape may be a cross, the fiducial point being defined by the point of intersection of the lines defining the cross or the shape may be a circle, the fiducial point being defined by the centre of the circle. Other suitable shapes include without limitation squares, triangles, and concentric rings. With regard to the circuit board one or more fiducial points may be defined by component attachment pads on the circuit board.

The stencil advantageously has a plurality of fiducial points arranged in relation to its surface and the circuit board has a corresponding plurality of fiducial points arranged in relation to its surface, and preferably the step of ascertaining the relative orientation of the circuit board to the stencil from the signals sent from the camera system is performed by ascertaining the orientation of the fiducial points on the stencil relative to the fiducial points on the circuit board. In the case where data relating to a particular type of stencil and circuit board is stored, the data advantageously includes data relating to fiducial points.

Preferably, the fiducial points are so arranged that once the circuit board holder and stencil holder have been moved relative to each other, so that the printing machine is able to print a substance onto the circuit board in the desired orientation, the fiducial points on the circuit board are aligned with the fiducial points on the stencil. Preferably, each respective pair of fiducial points are in exact alignment. Sometimes, a stencil and a circuit board manufactured for use in conjunction with each other are such that the shapes defining the fiducial points on the stencil are not in exact alignment with the shapes defining the fiducial points on the circuit board. Such alignment errors can be introduced during manufacture of the stencil and/or the circuit board. The method therefore preferably includes a step in which such errors can be ascertained and compensated for. For example, certain fiducial points can be redefined in relation to the shape concerned, for example by manually inputting an offset value.

The method advantageously further includes a step in which the printing machine is calibrated. The calibration step may include the following steps:

loading a test fixture onto at least one of the circuit board holder and the stencil holder, the test fixture including a predetermined pattern visible by the camera system, data concerning the orientation of the pattern on the test fixture being held in memory of the control unit,

sending signals from the control unit to perform movements of the circuit board holder and stencil holder relative to each other and simultaneously viewing with the camera system the test fixture,

sending signals from the camera system to the control unit,

ascertaining parameters relating to the printing machine from the signals received from the camera system and the data held in the control unit relating to the test fixture, and storing the parameters in memory of the control unit.

Thus after a given printing machine has been manufactured, any errors that could arise from differences between the dimensions of components of the machine (even if the differences between the component as specified and the component as manufactured are within acceptable tolerances) can, by using such parameters, be compensated for. The test fixture may be in the form of a test board.

Preferably, the circuit board holder and stencil holder are so arranged that a circuit board secured to the circuit board holder lies, in use, on a plane that is substantially parallel to the plane on which the stencil lies. The circuit board holder and stencil holder are preferably so arranged that the circuit board and stencil are able to be rotated relative to each other and are able to be translated relative to each other.

The circuit board holder and stencil holder are preferably so arranged that the circuit board holder and the stencil holder are able to be translated relative to each other in two non-parallel directions substantially parallel to the plane in which the stencil lies, the step of moving the circuit board holder and stencil holder relative to each other from the load position towards the print position being able to be effected by translating the circuit board holder and the stencil holder relative to each other in one of those two directions. Thus, there need only be one additional independent prime mover to effect relative translational aligning movement in the plane in which the stencil lies, the relative translational aligning movement in the other direction parallel to the plane on which the stencil lies being effected by an independent prime mover that also effects the movement of the circuit board holder and stencil holder relative to each other between the load position and the print position. Said two non-parallel directions need not be, but are conveniently, substantially perpendicular to each other.

Preferably the printing machine includes guides to guide the relative movement of the circuit board holder and stencil holder relative to each other between the load position and the print position.

The printing machine is preferably provided with an independent prime mover that is able in use to effect movement of the circuit board holder and stencil holder relative to each other in a direction substantially perpendicular to the plane on which the stencil lies. Preferably, the printing machine includes guides to guide that movement. The method preferably further includes a step in which data is entered into the control unit enabling the thickness of either or both of the stencil and the circuit board to be compensated for.

The stencil holder is preferably stationary during the relative movement of the circuit board holder and stencil holder.

Preferably, one of the circuit board holder and stencil holder is provided with two independent prime movers. Advantageously, the two prime movers, the circuit board holder and the stencil holder are so arranged that the prime movers are able to impart relative translational movement of the circuit board relative to the stencil (for example the arrangement may be such that translational movement is effected when the two prime movers each impart motion of the same velocity) and so arranged that the prime movers are able to impart relative rotational movement of the circuit board relative to the stencil (for example the arrangement may be such that rotational movement is effected when the two prime movers each impart motion of a different velocity). Thus, the amount of relative translational movement compared to the amount of relative rotational movement may be determined by the respective rates at which the prime movers drive. Preferably, the two prime movers, the circuit board holder and the stencil holder are so arranged that the prime movers are able to impart relative translational movement of the circuit board relative to the stencil without imparting relative rotational movement. Preferably, the two prime movers, the circuit board holder and the stencil holder are so arranged that the prime movers are able to impart relative rotational movement of the circuit board relative to the stencil without imparting relative translational movement. Advantageously, the two prime movers, the circuit board holder and the stencil holder are so arranged that the two prime movers are able only to impart motion that has components of rotational movement about a known axis and translational movement in one direction only. For example, movement of the circuit board holder relative to the stencil holder imparted by the two prime movers may be guided by a single rotary bearing and a single linear bearing. Having such an arrangement simplifies considerably the calculations necessary to effect alignment, since translational movement of the circuit board relative to the stencil in a second direction may be provided by a separate prime mover and bearing system, independent of the motion imparted by said two prime movers.

Different circuit boards may require different means to enable the board to be sufficiently well secured to the circuit board holder. Thus, preferably, the or a part of the circuit board holder is removably secured to the printing machine and the method includes a step of replacing the or said part of the circuit board holder with a different circuit board holder or part.

Preferably, the step of printing the substance onto the circuit board is performed by means of a screen printing process and more preferably by a stencil printing process. The substance printed may be an adhesive conducting paste, solder paste, a substance including ink or any other suitable substance.

Preferably, the stencil has a pattern of gaps or apertures which define the pattern in which the substance is printed on the circuit board. In that case, the step of printing the substance onto the circuit board may include the following steps: effecting relative movement of the stencil and the circuit board, so that the stencil and circuit board are brought into contact (or directly adjacent to each other, there being a small separation between the stencil and circuit board); pushing with a wiper a substance along the surface of the stencil furthest from the circuit board so that the substance is forced into the gaps or apertures of the stencil; and effecting relative movement of the stencil and the circuit board, so that the stencil and circuit board are moved apart. The force that the wiper and stencil exert against each other is preferably adjustable and is more preferably pre-programmable.

The present invention also provides a printing machine for printing a substance onto a circuit board in a predetermined pattern and substantially in accordance with a desired orientation as set forth in claim 18 of the claims attached hereto. The printing machine may be so arranged and configured that the machine is suitable for use in a method of printing as described above with reference to the present invention.

According to a particularly advantageous aspect of the present invention there is provided a method of printing a substance onto a circuit board in a predetermined pattern and substantially in accordance with a desired orientation comprising the steps of

a) providing a printing machine comprising

a circuit board holder to which a circuit board may be secured,

a stencil holder to which a stencil is secured,

a camera system comprising a first camera and a second camera and

a control unit, wherein

the circuit board holder and stencil holder are so arranged that they are movable relative to each other in a first direction between a load position, in which a circuit board may be secured to or released from the circuit board holder, and a print position in which the printing machine is able to print a substance onto a circuit board secured to the circuit board holder in a pattern determined by the stencil and in an orientation determined by the relative orientation of the circuit board holder and the stencil holder,

the circuit board holder and stencil holder are so arranged that said relative orientation is adjustable, the first camera is mounted such that movement of the stencil holder relative to the circuit board holder causes movement of the first camera relative to the circuit board holder, the first camera being arranged to view a portion of the circuit board, and being arranged to be movable relative to the stencil holder in a direction transverse to the first direction, and

the second camera is mounted such that movement of the circuit board holder relative to the stencil holder causes movement of the second camera relative to the stencil holder, the second camera being arranged to view a portion of the stencil, and being arranged to be movable relative to the circuit board holder in a direction transverse to the first direction,

b) with the circuit board holder and stencil holder in the load position, loading a circuit board onto the circuit board holder,

c) effecting relative movement of the circuit board holder and stencil holder from the load position towards the print position in the first direction,

d) during the movement of the circuit board holder and stencil holder in the first direction, viewing different portions of the circuit board and the stencil with the first and second cameras, respectively, by moving each of the first and second cameras in a direction transverse to the first direction, the movement of the cameras being controlled by the control unit

e) sending signals from the camera system to the control unit,

f) ascertaining the relative movement required to position the circuit board holder and stencil holder relative to each other so that the printing machine is able to print a substance onto the circuit board in the desired orientation, including a step of ascertaining the relative orientation of the circuit board and the stencil from the signals sent from the camera system and data in the control unit relating to the relative orientation of the stencil,

g) the control unit effecting movement of the circuit board holder and stencil holder relative to each other in accordance with the relative movement so ascertained, and then

h) printing a substance onto the circuit board.

The present invention also provides, in accordance with that aspect of the invention, a printing machine for use in that method, the printing machine thus being able to print a substance onto a circuit board in a predetermined pattern and substantially in accordance with a desired orientation. Such a printing machine preferably comprises

a) a printer for printing a substance on a circuit board,

b) a circuit board holder to which the circuit board may be secured and a stencil holder to which a stencil may be secured,

the circuit board holder and stencil holder being so arranged that they are movable relative to each other in a first direction between a load position, in which a circuit board may be secured to or released from the circuit board holder, and a print position in which the printer is able to print a substance onto a circuit board secured to the circuit board holder in a pattern determined by a stencil secured to the stencil holder and in an orientation determined by the relative orientation of the circuit board holder and the stencil holder,

the circuit board holder and stencil holder also being so arranged that said relative orientation is adjustable,

c) a camera system comprising a first camera and a second camera,

wherein the first camera is mounted such that movement of the stencil holder relative to the circuit board holder causes movement of the first camera relative to the circuit board holder,

the first camera being arranged to view a portion of the circuit board, and being arranged to be movable relative to the stencil holder in a direction transverse to the first direction,

wherein the second camera is mounted such that movement of the circuit board holder relative to the stencil holder causes movement of the second camera relative to the stencil holder,

the second camera being arranged to view a portion of the stencil, and being arranged to be movable relative to the circuit board holder in a direction transverse to the first direction,

wherein the first and second cameras are able to view, whilst the circuit board holder and stencil holder move relative to each other from the load position towards the print position, portions of a circuit board secured to the circuit board holder and a stencil secured to the stencil holder, respectively, and

wherein the camera system is able to send signals relating to the images so viewed, and

d) a control unit arranged to receive, in use, signals from the camera system and able to ascertain from said signals the relative orientation of the circuit board and the stencil, thereby enabling the control unit, in use, to send signals to effect movement of the circuit board holder and stencil holder relative to each other to a position in which the printer is able to print a substance onto the circuit board substantially in accordance with the desired orientation.

The advantages of the present invention may have application in other fields of printing, for example, for medical purposes. The present invention in its broadest form thus further provides a method of printing a substance onto a substrate in a predetermined pattern and substantially in accordance with a desired orientation comprising the steps of

a) providing a printing machine comprising a substrate holder to which a substrate may be secured,

a stencil holder to which a stencil is secured,

a camera system comprising at least one camera and a control unit, wherein

the substrate holder and stencil holder are so arranged that they are movable relative to each other between a load position, in which a substrate may be secured to or released from the substrate holder, and a print position in which the printing machine is able to print a substance onto a substrate secured to the substrate holder in a pattern determined by the stencil and in an orientation determined by the relative orientation of the substrate holder and the stencil holder, and wherein the substrate holder and stencil holder are so arranged that said relative orientation is adjustable,

b) with the substrate holder and stencil holder in the load position, loading a substrate onto the substrate holder,

c) moving the substrate holder and stencil holder relative to each other from the load position towards the print position,

d) during the step of moving the substrate holder and stencil holder from the load position towards the print position, viewing the substrate with the camera system,

e) sending signals from the camera system to the control unit,

f) ascertaining the relative movement required to position the substrate holder and stencil holder relative to each other so that the printing machine is able to print a substance onto the substrate in the desired orientation, including a step of ascertaining the relative orientation of the substrate and the stencil from the signals sent from the camera system and data in the control unit relating to the relative orientation of the stencil,

g) moving the substrate holder and stencil holder relative to each other in accordance with the relative movement so ascertained, and then

h) printing a substance onto the substrate.

The invention also provides a printing machine suitable for use in such a method. The substrate may, for example, have different substances arranged in different locations on the substrate and the substance to be printed may be a reagent that needs to be deposited on the substrate in a particular pattern and orientation. Such a method of printing may therefore be of use in testing and diagnostics methods, especially in any one of chemical, medical and biotechnological fields. Features mentioned above with reference to the aspect of the invention relating to printing substances on circuit boards may, of course, be incorporated into this further aspect of the invention relating to printing substances on substrates.

By way of example an embodiment of the present invention will now be described with reference to the accompanying schematic drawings of which:

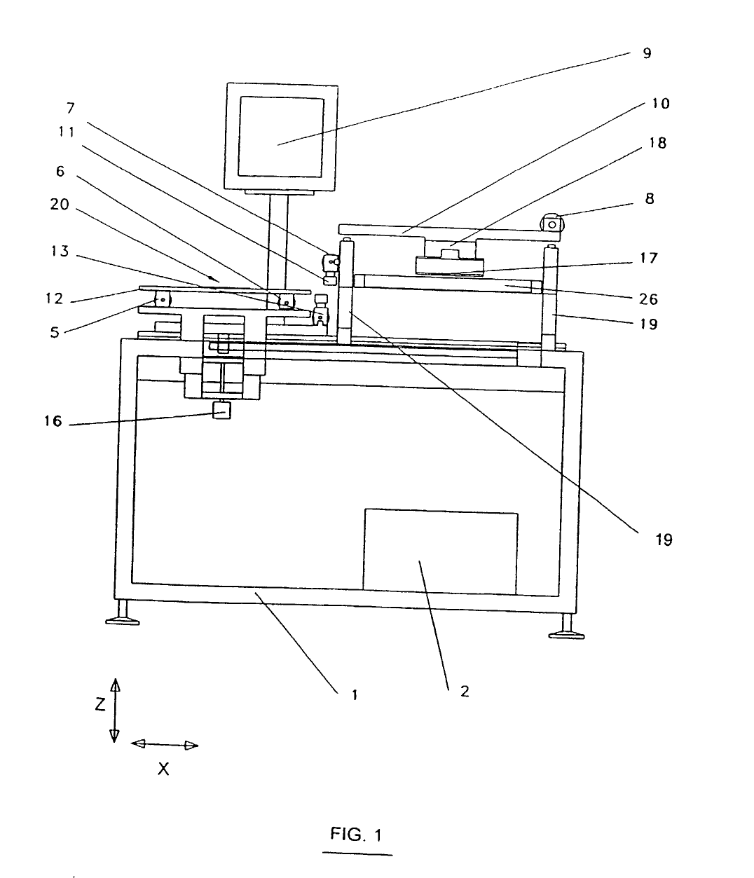

FIG. 1 is a front view of a printing machine,

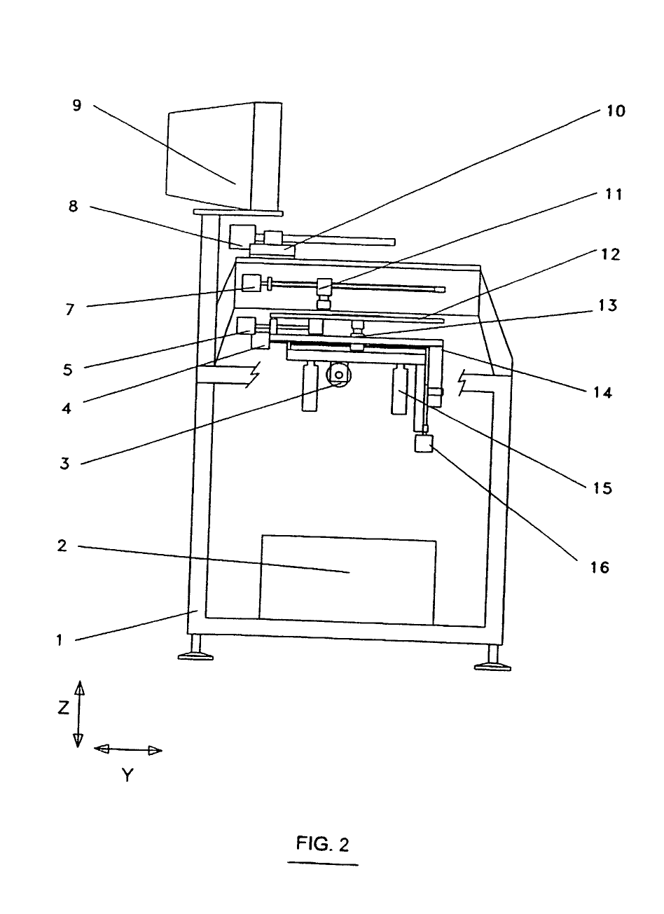

FIG. 2 is a side view of the printing machine of FIG. 1, and

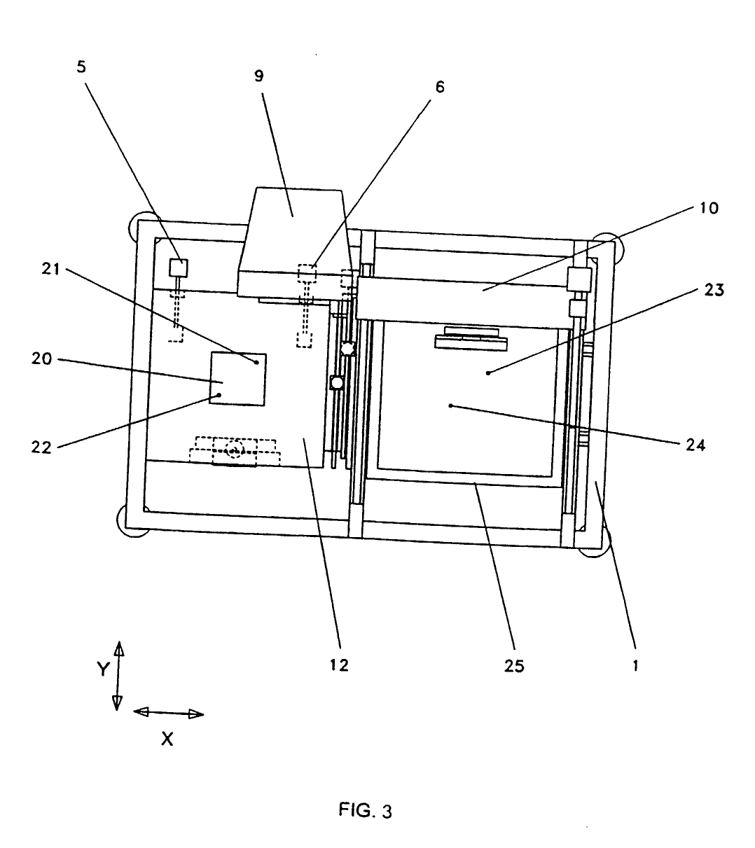

FIG. 3 is a plan view of the printing machine of FIG. 1.

The Figures each show the printing machine as viewed in three notional orthogonal axes. Those notional axes, x, y and z, which are referred to below, are indicated on the drawings with arrows labelled accordingly.

FIGS. 1 to 3 show a printing machine, according to an embodiment of the present invention, for printing solder paste on a PCB (printed circuit board) in a pattern determined by a stencil. The PCBs on which the machine prints solder paste each have a wiring circuit etched on their surfaces. The machine is able to print solder paste onto the surface of a PCB in one printing operation in a pattern that then enables components to be quickly and easily connected to the PCB. There is therefore a notional ideal orientation of the pattern of printed solder paste relative to the wiring pattern on the circuit board. The printing machine is able to align automatically the stencil and the circuit board so that the pattern of solder paste is printed on the circuit board in an orientation identical to that ideal orientation or in an orientation, though different to the ideal orientation, sufficiently close to the ideal orientation that the error in alignment is acceptable.

The printing machine includes a frame 1, a PCB alignment table 12 for accommodating a PCB 20 and a stencil frame 25 for accommodating a stencil 26. The machine frame 1 includes four adjustable feet. Various guards and covers of the machine provided, for example, for the safety of the operator of the machine are not shown for the sake of clarity.

Most of the operation of the printing machine is controlled by a control unit (not shown) housed in the electronics enclosure 2.

The PCB alignment table 12 is movably mounted on a lift table 14, which is itself movable in a vertical direction (parallel to the z-axis). The lift table 14 is driven by a lift motor 16, and is able to move the PCB alignment table 12 in a direction parallel to the z-axis, the movement being guided by linear bearings. The PCB table 12 is mounted for translational movement in directions parallel to the x and y axes and for rotation within a plane parallel to the x and y axes. Motors 3, 6, 7 are provided to effect such movement. The motors 3, 6, 7 are controlled by the control unit. One x-axis motor 3 is provided to move the table 12 in a direction parallel to the x-axis, the motion being guided by x-axis table guides 15 including suitable linear bearings for supporting the table 12. The alignment table 12 is movable, in a direction parallel to the x-axis, by the x-axis motor 3 between a “load position” (as shown in the Figures), in which a PCB may be secured to or released from the alignment table 12, and a “print position”, in which the PCB lies directly beneath the stencil 26 so that the printing machine is able to print a substance onto the PCB.

Two y-axis motors 5, 6 are provided to move the table 12 in a direction parallel to the y-axis. The table 12 is so mounted that when the two y-axis motors 5, 6 are driven in the same direction and at the same rate the table moves parallel to the y-axis without any rotational component and so that when the y-axis motors 5, 6 are driven at different rates (for example in opposite directions) the table 12 moves with a component of rotational movement about an axis parallel to the z-axis.

The PCB 20 is secured to the table 12 by means of an adapter (not shown) fixed to the table that enables the given type of PCB to be secured to the table 12. The PCB is securely held in place by the adapter by means of a variety of mechanical fixings and by a vacuum suction means (not shown).

The stencil frame 25 is fixedly mounted to the machine frame 1. The stencil 26, which typically has a thickness of between 0.1 mm and 1.0 mm, is removably secured to the frame 25 and the frame has the ability to accommodate and secure stencils of different shapes and sizes. Above the stencil frame 25 and stencil 26 is mounted a print carriage 10 movable in a direction parallel to the y-axis, the movement being guided by guides. The print carriage 10 is movably mounted on print carriage supports 19, which are fixed to the frame 1, and is driven by a print carriage motor 8.

Two squeegees 17 are mounted on the print carriage 10 (only one of which being shown in the Figures), the squeegees 17 being movable by respective squeegee moving mechanisms 18 in a direction parallel to the z-axis. Each squeegee 17 contacts the stencil 26 during the step in which solder paste is printed on the PCB 20. Each squeegee moving mechanism 18 is so arranged that the contact force between its squeegee 17 and the stencil 26 is controllable by the control unit, which enables better control of the printing process. Each squeegee is thus able to be moved relative to the stencil both in a direction parallel to the y-axis (by movement of the print carriage 10) and in a direction parallel to the z-axis (by means of the squeegee moving mechanism 18). The two squeegees may be arranged to move in directions parallel to each other. Alternatively one of the two squeegees may be arranged to move in directions parallel to the z-axis and the x-axis (rather than the y-axis).

A camera system comprising CCD monochrome cameras 11, 13 is also provided. A board camera 11 for viewing the PCB 20 is movably mounted, for movement in a direction parallel to the y-axis, on the left hand (as viewed in FIGS. 1 and 3) carriage support 19. Movement of the board camera 11 is driven by board camera motor 7 and is guided by y-axis linear guides. A stencil camera 13 for viewing the stencil 26 is movably mounted, for movement in a direction parallel to the y-axis, on the right hand side (as viewed in FIGS. 1 and 3) of the PCB alignment table 12. The movement of the stencil camera 11 in the y direction is driven by stencil camera motor 4 and is guided by y-axis linear guides. Of course, the stencil camera 13 moves with the alignment table 12 if moved. Each camera is provided with a light source for illuminating the region of the object to be viewed and a suitable lens system The cameras are connected to the control unit to send signals relating to the images detected by the cameras to the control unit to be processed.

Both the PCB 20 and the stencil 26 are provided with shapes defining notional fiducial points 21, 22, 23, 24. The shapes defining fiducial points 21, 22 on the PCB 20 are produced during the etching process performed to produce the electrical wiring circuit (not shown). The shapes defining the fiducial points 23, 24 on the stencil 26 are produced during manufacture of the stencil 26 and mirror exactly (or very nearly) the fiducial points on the PCB.

All of the motors of the printing machine mentioned above are controlled by the control unit. The objects driven by the motors can be positioned reliably by means of driving the motors by selected amounts. The objects driven by the motors are driven without slippage.

The machine also includes a video display unit, for use together with a keyboard and mouse (not shown) as an operator interface 9, enabling information concerning the operation of the machine to be displayed to the operator.

The printing machine is designed to be used with many different stencils. The machine is able with any given stencil to print solder paste onto the surface of a multiplicity of PCBs each having the same wiring circuit.

To eliminate component and assembly variations, after building or servicing the printing machine, the machine is calibrated to optimise its accuracy. The calibration of the machine includes performing a series of camera and alignment table movements and capturing images of a test fixture with the camera system. Data concerning the true linearity and performance of the components of the machine are then calculated and stored in memory for use when the machine is operated to improve its accuracy. A skilled technician normally performs such calibration.

The normal operation of the machine can be divided into three activities: “New Product Set-up”, “Product Set-up” and “Run”. In order to perform a “Run”, the machine must first be set-up; by performing a “product set-up”. If the particular product is new to the machine it is necessary also to perform a “New Product Set-up”. The three activities will now be described.

New Product Set-up: During a New Product Set-up parameters are stored relating to a specific type of PCB. The machine is able to store a large number of PCB “recipes” into non-volatile memory, the “recipes” being usable for future “Run” operations. During the New Product Set-up process the machine is programmed with product and process parameters, via the Operator Interface 9. Product parameters include circuit board physical dimensions, and information concerning fiducial points (including fiducial locations, and the shapes and sizes thereof that define the fiducial points). Process parameters include information concerning print speed, print force etc. A typical New Product Set-up process (relating to a stencil for printing on PCBs of the same type) includes the following steps:

STEP 1—The operator creates and names a new product “recipe” file. Known product and process data will be added to this unique file via the Operator Interface 9.

STEP 2—With the alignment table 12 at the load position, a suitable adapter to support and secure the PCB is fitted to the top of the alignment table 12. A PCB is then loaded and secured to the table 12.

STEP 3—The appropriate stencil 26 is loaded and secured to stencil frame 25.

STEP 4—The operator manually positions, with a printing device, such as a joystick, via the operator interface 9, the PCB camera 11, stencil camera 13 and alignment table 12 to position the shapes defining the board and stencil fiducial points 21, 22, 23, 24 approximately in the centre of field of view of the appropriate camera. Once a shape is positioned within the field of vision of a camera, the vision system of the control unit is taught the shape and establishes a unique fiducial point, which in use will enable the vision system to ascertain the relative orientation of the PCB and stencil. Under normal circumstances the board and stencil fiducial points will be aligned in the z-direction. However, due to variations in board and stencil manufacture corresponding fiducial points may not be exactly aligned when viewed in the z-direction. In that case, each mis-aligned fiducial point can be offset by manually inputting the required value.

(As an alternative to this part of step 4, the operator may manually enter PCB fiducial point X-Y co-ordinates during STEP 1.)

Once the control unit has learnt the locations, shapes and sizes of the fiducial shapes, the table 12 and camera system 11, 13 complete an automatic alignment cycle. As the table 12 moves from the load position to the print position, images of the board 20 and of the stencil 26 are captured, signals being sent to the control unit, which ascertains the relative orientations of the stencil and board, and then calculates and moves the table with the x-axis motor 3 and y-axis motors 5, 6 to align the PCB 20 with the stencil 26.

STEP 5—With the table 12 in the aligned print position the PCB 20 is raised to contact the stencil 26. Print medium is added to the stencil 26 and a preliminary print cycle is executed by engaging the squeegee 17 with the stencil 26 and moving the print carriage 10 in the y-direction.

STEP 6—The operator then inspects the PCB and is likely to perfect the printing operation by adding and amending parameters. When this is complete, parameters and alignment data is stored to non volatile memory for future use by the control unit.

Product Set-Up—Product set-up is effected by performing the following steps:

Load the relevant product profile (“recipe”) from the non volatile memory into the operational memory of the control unit, the product profile defining the parameters such as axis co-ordinates and sequences to suit the type of PCB to be printed on.

Load the appropriate stencil 26 into the machine.

Mount an appropriate adapter onto the top of the alignment table 12 to locate and secure the PCBs. The relative positioning of the adapter on the table 12 is important.

The shapes defining the fiducial points should appear within the relevant camera's field of view. Preferably, the adapter is so positioned that the position of a PCB secured to the adapter is approximately the same (within±3.0 mm) as the position of the PCB during the New Product Set-up.

Mount the appropriate type and length of squeegees 17 to the squeegee moving mechanism 18.

Add print medium.

Run—Having completed the Product Set-up, the machine is ready to print a quantity of PCB's by performing the following steps:

The operator loads a PCB 20 onto the adapter, and closes the table cover (not shown in the drawings), which is used to start the Run cycle.

The table 12 moves from the load position to the print position. During this move the table 12, stencil camera 13 and board camera 11 complete a series of moves to capture the board's fiducial points 21, 22 and stencil's fiducial points 23, 24. Appropriate signals are sent from the cameras to the control unit. The relative errors of alignment are calculated by the control unit, which is then able to move the table 12 to the print position with the PCB 20 in correct alignment with the stencil.

The table 12 is then raised by the lift table 14 driven by the lift motor 16, placing the PCB 20 at the correct height ready for printing, which is then effected. The table 12 is then lowered and moved to the load position where the table cover is automatically opened so presenting the printed PCB 20 to the operator for removal. The operator may then replace the printed PCB with an unprinted PCB, the cycle being repeatable many times.

In order to reduce operation time, the stencil camera 13 normally only views the stencil 26 on product set-up or if the stencil 26 is moved. Information relating to the orientation of the stencil 26 relative to the machine is calculated and stored for future use by the control unit during the alignment process. A combined board and stencil alignment cycle is however completed periodically, and after the machine has been left dormant for a period.

It will be appreciated that various modifications may be made to the above-described embodiment of the invention. By way of example, some such modifications will now be described.

The adapter fixed to the alignment table 12 need not be removable, but may be fixed to the table 12 and provided with adjustable mechanical fixings that enable the adapter to accommodate a wide variety of differently shaped and sized PCBs.

The stencil frame 25 may be removably secured to the machine, whereby the frame 25 may be removed and replaced with a different frame. Stencils may then be permanently fixed to respective frames by means of, for example, adhesive.

The loading and unloading of PCBs to and from the machine could be performed automatically. The machine could, for example, be configured for use in an in-line operation. For example, PCBs could be conveyed to the PCB table by means of a conveyor belt. PCBs could alternatively be loaded and unloaded by means of a suitably programmed robot. Such methods of loading and unloading PCBs are well known in the art and do not therefore merit further description here.

1. A method of printing a substance onto a circuit board in a predetermined pattern and substantially in accordance with a desired orientation comprising the steps of
a) providing a printing machine comprising
a circuit board holder to which a circuit board may be secured,
a stencil holder to which a stencil is secured,
a camera system comprising at least one moveably mounted camera and a control unit, wherein
the circuit board holder and stencil holder are so arranged that they are movable relative to each other between a load position, in which a circuit board may be secured to or released from the circuit board holder, and a print position in which the printing machine is able to print a substance onto a circuit board secured to the circuit board holder in a pattern determined by the stencil and in an orientation determined by the relative orientation of the circuit board holder and the stencil holder,
the circuit board holder and stencil holder are so arranged that said relative orientation is adjustable, and wherein said at least one camera is so mounted that relative movement of the circuit board holder and the stencil holder causes movement of the camera relative to one of the circuit board holder and the stencil holder and is so mounted that the camera is traversable relative to either or both of the circuit board holder and the stencil holder.
b) with the circuit board holder and stencil holder in the load position, loading a circuit board onto the circuit board holder,
c) moving the circuit board holder and stencil holder relative to each other from the load position towards the print position,
d) during the step of moving the circuit board holder and stencil holder from the load position towards the print position, viewing the circuit board with the camera system,
e) sending signals from the camera system to the control unit,
f) ascertaining the relative movement required to position the circuit board holder and stencil holder relative to each other so that the printing machine is able to print a substance onto the circuit board in the desired orientation, including a step of ascertaining the relative orientation of the circuit board and the stencil from the signals sent from the camera system and data in the control unit relating to the relative orientation of the stencil,
g) moving the circuit board holder and stencil holder relative to each other in accordance with the relative movement so ascertained, and then
h) printing a substance onto the circuit board.

2. A method according to claim 1, wherein said at least one camera is mounted for viewing a circuit board, relative movement of the stencil holder between the load position and the print position causes relative movement of the camera in a first direction relative to the circuit board, and the camera is mounted for movement relative to the stencil holder in a second direction transverse to the first direction, so that the camera is able to move to view different regions of the circuit board.

3. A method according to claim 1 or claim 2, wherein the camera system includes two cameras, one camera of which is mounted for viewing a stencil, wherein relative movement of the circuit board holder between the load position and the print position causes relative movement of said one camera in a first direction and said one camera is mounted for movement relative to the circuit board holder in a second direction transverse to the first direction, so that the camera is able to move to view different regions of the stencil.

4. A method according to any preceding claim, wherein the signals from the camera system used by the control unit relate to an image of part of the object viewed by the relevant camera, the object being the circuit board or the stencil.

5. A method according to any preceding claim, wherein a camera of the camera system is able to view only part of an object viewed by that camera, and the camera is able to be moved relative to the object in two non-parallel directions parallel to the plane on which the object lies, the object being the circuit board or the stencil.

6. A method according to claim 5, wherein the step of moving the circuit board holder and stencil holder relative to each other between the load position and the print position effects movement of the camera relative to the object in one of the said two non-parallel directions.

7. A method according to claim 6, wherein the camera is movable in the other of the said two non-parallel directions independently of the circuit board holder and the stencil holder.

8. A method according to any preceding claim, wherein the camera system comprises two cameras, one of which is arranged to view the circuit board and the other of which is arranged to view the stencil.

9. A method according to any preceding claim, wherein during step d) the stencil is viewed with the camera system, said data in the control unit relating to the relative orientation of the stencil being ascertained from the signals sent from the camera system to the control unit.

10. A method according to claim 9, wherein the method further includes the steps of
i) storing in the control unit said data relating to the relative orientation of the stencil,
j) moving the circuit board holder and stencil holder relative to each other from the print position to the load position and removing the circuit board,
k) loading a further circuit board onto the circuit board holder,
l) moving the circuit board holder and stencil holder relative to each other from the load position towards the print position,
m) during the step of moving the circuit board holder and stencil holder from the load position towards the print position, viewing the further circuit board with the camera system,
n) sending signals from the camera system to the control unit,
o) ascertaining the relative movement required to position the circuit board holder and stencil holder relative to each other so that the printing machine is able to print a substance onto the further circuit board in the desired orientation, including a step of ascertaining the relative orientation of the further circuit board and the stencil from the signals sent from the camera system and the data stored in the control unit concerning the relative orientation of the stencil,
p) moving the circuit board holder and stencil holder relative to each other in accordance with the relative movement so ascertained, and then
q) printing a substance onto the further circuit board.

11. A method according to claim 10, wherein the method further includes the steps of
r) repeating steps j) to q) a multiplicity of times,
s) performing steps j) to m), during step 1) viewing the stencil with the camera system, and sending signals from the camera system to the control unit, and
t) refreshing the data stored in the control unit relating to the relative orientation of the stencil.

12. A method according to any preceding claim, wherein the stencil is removably secured to the stencil holder, the printing machine is able to be used with a different stencil to print a substance in a different pattern and orientation on a circuit board and the control unit has a memory in which data relating to the stencil and the circuit board is held, the data enabling the machine to ascertain the relative orientation of the circuit board and the stencil from the signals sent from the camera system and to ascertain the relative movement required to position the circuit board holder and stencil holder relative to each other so that the printing machine is able to print a substance onto the circuit board substantially in accordance with the desired orientation, and wherein the method further includes a step in which a stencil is secured to the stencil holder, and a step in which data relating to a particular type of stencil and circuit board is stored in the memory of the control unit.

13. A method according to any preceding claim, further including a step in which the printing machine is calibrated, the calibration step including the following steps:
loading a test fixture onto at least one of the circuit board holder and the stencil holder, the test fixture including a predetermined pattern visible by the camera system, data concerning the orientation of the pattern on the test fixture being held in memory of the control unit,
sending signals from the control unit to perform movements of the circuit board holder and stencil holder relative to each other and simultaneously viewing with the camera system the test fixture,
sending signals from the camera system to the control unit,
ascertaining parameters relating to the printing machine from the signals received from the camera system and the data held in the control unit relating to the test fixture, and
storing the parameters in memory of the control unit.

14. A method according to any preceding claim, wherein the circuit board holder and stencil holder are so arranged that the circuit board holder and the stencil holder are able to be translated relative to each other in two non-parallel directions substantially parallel to the plane in which the stencil lies, the step of moving the circuit board holder and stencil holder relative to each other from the load position towards the print position being able to be effected by translating the circuit board holder and the stencil holder relative to each other in one of those two directions.

15. A method according to any preceding claim, wherein one of the circuit board holder and stencil holder is provided with two independent prime movers, the two prime movers, the circuit board holder and the stencil holder being so arranged that the prime movers are able to impart relative translational movement of the circuit board relative to the stencil and so arranged that the prime movers are able to impart relative rotational movement of the circuit board relative to the stencil, the amount of relative translational movement compared to the amount of relative rotational movement being determined by the respective rates at which the prime movers drive.

16. A method according to any preceding claim, wherein the step of printing the substance onto the circuit board is performed by means of a stencil printing process.

17. A method according to any preceding claim, wherein the substance printed is solder paste.

18. A printing machine for printing a substance onto a circuit board in a predetermined pattern and substantially in accordance with a desired orientation comprising
a printer for printing a substance on a circuit board,
a circuit board holder to which the circuit board may be secured and a stencil holder to which a stencil may be secured, the circuit board holder and stencil holder being so arranged that they are movable relative to each other between a load position, in which a circuit board may be secured to or released from the circuit board holder, and a print position in which the printer is able to print a substance onto a circuit board secured to the circuit board holder in a pattern determined by a stencil secured to the stencil holder and in an orientation determined by the relative orientation of the circuit board holder and the stencil holder, the circuit board holder and stencil holder also being so arranged that said relative orientation is adjustable,
a camera system comprising at least one movably mounted camera, the camera system being i) able to view a stencil secured to the stencil holder, ii) able to view, whilst the circuit board holder and stencil holder move from the load position towards the print position, a circuit board secured to the circuit board holder, iii) able to send signals relating to the images so viewed, and (iv) so arranged that said at least one movably mounted camera is able to traverse relative to either or both of the circuit board holder and the stencil holder and
a control unit arranged to receive, in use, signals from the camera system and able to ascertain from said signals the relative orientation of the circuit board and the stencil, thereby enabling the control unit, in use, to send signals to effect movement of the circuit board holder and stencil holder relative to each other to a position in which the printer is able to print a substance onto the circuit board substantially in accordance with the desired orientation.

19. A printing machine according to claim 18, wherein the machine is so arranged and configured that the machine is suitable for use in the method of any of claims 1 to 17.

20. A method of printing a substance onto a circuit board in a predetermined pattern and substantially in accordance with a desired orientation comprising the steps of
a) providing a printing machine comprising
a circuit board holder to which a circuit board may be secured,
a stencil holder to which a stencil is secured,
a camera system comprising two moveably mounted cameras and
a control unit, wherein
the circuit board holder and stencil holder are so arranged that they are movable relative to each other between a load position, in which a circuit board may be secured to or released from the circuit board holder, and a print position in which the printing machine is able to print a substance onto a circuit board secured to the circuit board holder in a pattern determined by the stencil and in an orientation determined by the relative orientation of the circuit board holder and the stencil holder,
the circuit board holder and stencil holder are so arranged that said relative orientation is adjustable,
one of said two cameras is mounted for viewing a circuit board, relative movement of the stencil holder between the load position and the print position causing relative movement of the camera in a first direction relative to the circuit board holder, the camera for viewing a circuit board also being mounted for movement relative to the stencil holder in a second direction transverse to the first direction, so that the camera is able to move to view different regions of the circuit board, and wherein the other of said two cameras is arranged for viewing the stencil,
b) with the circuit board holder and stencil holder in the load position, loading a circuit board onto the circuit board holder,
c) moving the circuit board holder and stencil holder relative to each other from the load position towards the print position,
d) during the step of moving the circuit board holder and stencil holder from the load position towards the print position, viewing the circuit board with the camera system,
e) sending signals from the camera system to the control unit,
f) ascertaining the relative movement required to position the circuit board holder and stencil holder relative to each other so that the printing machine is able to print a substance onto the circuit board in the desired orientation, including a step of ascertaining the relative orientation of the circuit board and the stencil from the signals sent from the camera system and data in the control unit relating to the relative orientation of the stencil, said data having been ascertained from signals sent from the camera system, the camera system having viewed the stencil before, or during a previous operating cycle of the machine,
g) moving the circuit board holder and stencil holder relative to each other in accordance with the relative movement so ascertained, and then
h) printing a substance onto the circuit board.
